(19) United States
(12) Patent Application Publication
(10) Pub. No.: US 2026/0129367 A1
(43) Pub. Date: May 7, 2026

(54) DIAPHRAGMS, AIR CONDUCTION SPEAKERS, AND WEARABLE ELECTRONIC DEVICES

(71) Applicant: SHENZHEN SHOKZ CO., LTD., Shenzhen (CN)

(72) Inventors: Guangyuan ZHU, Shenzhen (CN); Lei ZHANG, Shenzhen (CN); Xin QI, Shenzhen (CN); Shanyong GU, Shenzhen (CN)

(73) Assignee: SHENZHEN SHOKZ CO., LTD., Shenzhen (CN)

(21) Appl. No.: 19/435,677

(22) Filed: Dec. 29, 2025

Related U.S. Application Data
(63) Continuation of application No. PCT/CN2023/140260, filed on Dec. 20, 2023.

(51) Int. Cl. H04R 7/12; H04R 1/10; H04R 7/14; H04R 7/18

(52) U.S. Cl. CPC H04R 7/122; H04R 1/1008; H04R 7/127; H04R 7/14; H04R 7/18; H04R 2460/13

(57) ABSTRACT

The present disclosure relates to a diaphragm, an air conduction speaker, and a wearable electronic device. The diaphragm includes a center main body and a folded ring. The folded ring is connected to an outer peripheral edge of the center main body. The folded ring includes two arcuate segments and two connecting segments. The two arcuate segments are spaced apart and disposed opposite to each other. The two connecting segments are spaced apart side-by-side and connected one-to-one between two pairs of opposite ends of the two arcuate segments. Each arcuate segment is provided with a plurality of first pattern grooves spaced apart from each other along an extension direction of the arcuate segment. The plurality of first pattern grooves are arranged in a radial arrangement along a same spiral direction.

### CROSS-REFERENCE TO RELATED APPLICATIONS

This application is a continuation of International Patent Application No. PCT/CN2023/140260, filed on Dec. 20, 2023, the contents of which are hereby incorporated by reference.

### TECHNICAL FIELD

The present disclosure relates to the technical field of sound-emitting apparatus, and in particular to a diaphragm, an air conduction speaker, and a wearable electronic device.

### BACKGROUND

With the continuous popularization of wearable electronic devices, they have become indispensable social and entertainment tools in people's daily lives. Wearable electronic devices such as headphones and smart glasses have also been widely used in people's daily life, which can be used in conjunction with cell phones, computers, and other terminal devices to facilitate the provision of auditory feast for users. Thus, how to enhance the working life of wearable electronic devices, such as headphones, is an urgent problem at present

### SUMMARY

The present disclosure provides a diaphragm, comprising: a center main body; and a folded ring connected to an outer peripheral edge of the center main body. The folded ring includes two arcuate segments and two connecting segments, the two arcuate segments are spaced apart and disposed opposite to each other, and the two connecting segments are disposed spaced apart side-by-side and connected one-to-one between two pairs of opposite ends of the two arcuate segments. Each arcuate segment of the two arcuate segments is provided with a plurality of first pattern grooves spaced apart from each other in an extension direction of the arcuate segment, two ends of each first pattern groove extend towards an inner ring and an outer ring of the folded ring, respectively, and the plurality of first pattern grooves are arranged in a radial arrangement along a same spiral direction.

In some embodiments, a depth of each first pattern groove decreases gradually towards the two ends of the first pattern groove, and a width of a groove opening of the first pattern groove decreases gradually towards the two ends of the first pattern groove.

In some embodiments, a maximum depth of the first pattern groove is in a range of 0.06 mm˜0.1 mm, and a maximum width of the groove opening of the first pattern groove is in a range of 0.14 mm˜0.18 mm.

In some embodiments, a ratio of a depth of each first pattern groove at any position to a width of a groove opening of the first pattern groove is in a range of 0.5˜4.

In some embodiments, a groove wall of each first pattern groove includes a curved bottom wall and two side walls disposed opposite to each other, the curved bottom wall is connected between the two side walls and is disposed in a curved depression in a direction away from a groove opening of the first pattern groove, and the curved bottom wall and the two side walls are smoothly connected.

In some embodiments, an angle between the two side walls is in a range of 50°˜120°, or a range of 60° to 100°.

In some embodiments, the folded ring includes an inner ring folded edge, an outer ring folded edge, and an annular curved portion connected between the inner ring folded edge and the outer ring folded edge. The inner ring folded edge is connected to the center main body, and the plurality of first pattern grooves are opened in the annular curved portion and located in the annular curved portion at a position corresponding to an arcuate segment of the two arcuate segments. Each first pattern groove has a first end proximate to the inner ring folded edge and a second end proximate to the outer ring folded edge, and a distance between the first end and the inner ring folded edge is less than a distance between the second end and the outer ring folded edge.

In some embodiments, the folded ring has a long axis direction and a short axis direction perpendicular to each other, the two connecting segments extend along the long axis direction and are spaced apart along the short axis direction, on a reference plane defined by the long axis direction and the short axis direction, each first pattern groove has a first projection, and an inner edge of the folded ring has a second projection, the second projection and an extension line of the first projection have an intersection point on the reference plane, and at the intersection point, an angle between the extension line of the first projection and a tangent line of the second projection is greater than or equal to 30° and less than 90°.

In some embodiments, the angle corresponding to the first pattern groove decreases gradually along a direction from a middle point of an arcuate segment of the two arcuate segments towards each end of the arcuate segment. The angle corresponding to the first pattern groove closer to the middle point of the arcuate segment is larger, and the angle corresponding to the first pattern groove closer to each end of the arcuate segment is smaller.

In some embodiments, the plurality of first pattern grooves of the two arcuate segments have the same spiral direction.

In some embodiments, at least one of the two connecting segments is provided with a plurality of second pattern grooves spaced apart from each other, two ends of each second pattern groove extending towards the inner ring and the outer ring of the folded ring, respectively.

In some embodiments, the folded ring has a long axis direction and a short axis direction perpendicular to each other, the two connecting segments extend along the long axis direction and are spaced apart along the short axis direction, an angle between the short axis direction and an extension direction of a projection of a second pattern groove of the plurality of second pattern grooves on a reference plane defined by the long axis direction and the short axis direction is less than 5°.

In some embodiments, the plurality of second pattern grooves are divided into at least two groups of second pattern grooves, in each group of second pattern grooves, there is a first interval distance between two second pattern grooves that are adjacent to each other, there is a second interval distance between two adjacent groups of second pattern grooves, the first interval distance is less than the second interval distance, there is a third interval distance between a second pattern groove of the plurality of second pattern grooves and a first pattern groove of the plurality of first pattern grooves that is closest to each other, and the first interval distance is less than the third interval distance.

The present disclosure provides an air conduction speaker, comprising: a magnet assembly provided with a magnetic gap extending along a preset vibration direction; a frame fixedly enclosed around a periphery of the magnet assembly; a diaphragm having an outer peripheral edge fixed to the frame and disposed opposite to the magnet assembly; and a voice coil. One end of the voice coil is fixedly connected to the diaphragm and another end of the voice coil extends into the magnetic gap. A lower surface of the diaphragm towards the magnet assembly has a connecting position connected to one end of the voice coil, the magnet assembly has a top surface toward the diaphragm along the preset vibration direction, the diaphragm has a longest dimension in a direction perpendicular to the preset vibration direction, in a natural stationary state, there is a first spacing dimension between the connecting position and the top surface in the preset vibration direction; and a ratio of the first spacing dimension to the longest dimension is in a range of 0.1˜0.2.

In some embodiments, the diaphragm is provided in a runway shape having a long axis direction and a short axis direction perpendicular to each other, and the diaphragm has the longest dimension along the long axis direction.

In some embodiments, the magnetic gap is provided in an annular shape, the magnet assembly includes a middle portion surrounded by the magnetic gap, and the top surface is an upper surface of the middle portion facing the diaphragm.

In some embodiments, the magnet assembly includes a magnetic conduction shield, a magnet, and a magnetic conduction plate, the magnetic conduction shield is fixedly connected to the frame, the magnetic conduction shield encloses the magnet and the magnetic conduction plate, the magnetic conduction plate and the magnet are stacked, the magnetic conduction plate is closer to the diaphragm than the magnet, the magnet and the magnetic conduction plate serve as the middle portion, and the top surface is an upper surface of the magnetic conduction plate facing the diaphragm.

In some embodiments, in the natural stationary state, a portion of the voice coil extending between another end of the magnetic gap and the top surface has a second spacing dimension in the preset vibration direction, and a ratio of the second interval distance to the first interval distance is in a range of 0.85˜1.66.

In some embodiments, the magnetic gap has a gap bottom surface away from the connecting position, in the natural stationary state, there is a third spacing dimension between the connecting position and the gap bottom surface in the preset vibration direction, and a ratio of the third spacing dimension to the longest dimension is in a range of 0.15˜0.4.

In some embodiments, the diaphragm includes a folded ring and a center main body, the folded ring includes an inner ring folded edge and an outer ring folded edge, the outer ring folded edge surrounds the inner ring folded edge, the outer ring folded edge is fixed with respect to the frame, and the center main body includes a main body portion and an annular connecting edge connected to an outer peripheral edge of the main body portion. The inner ring folded edge and the annular connecting edge are connected in a layered manner, the connecting position is located on a lower surface toward the voice coil of one of the inner ring folded edge and the annular connecting edge close to the voice coil; and an angle between the lower surface where the connecting position is located and the preset vibration direction is greater than or equal to 80° and less than or equal to 90°.

In some embodiments, the annular connecting edge includes a first sub-connecting edge and a second sub-connecting edge, the first sub-connecting edge is connected around the main body portion, the second sub-connecting edge is connected around the first sub-connecting edge, the inner ring folded edge is stacked on the second sub-connecting edge, and the connecting position is located at a lower surface of the second sub-connecting edge toward the voice coil. The first sub-connecting edge and the second sub-connecting edge are connected at an angle within a range of 145°˜180°, and/or in the natural stationary state, an outer edge of the first sub-connecting edge connecting to the second sub-connecting edge is closer to the magnet assembly along the preset vibration direction as compared to an inner edge of the first sub-connecting edge connecting to the main body portion

In some embodiments, the annular connecting edge is bent in connection with the main body portion and the main body portion is arched in a direction away from the magnet assembly; and an orthographic projection of a portion at a bent connection position between the annular connecting edge and the main body portion on a reference plane perpendicular to the preset vibration direction falls within an orthographic projection of the magnetic gap on the reference plane.

In some embodiments, the frame is provided with an annular table surface; and the air conduction speaker includes an annular fixing member, the annular fixing member being fixedly connected to a side of an outer edge of the diaphragm facing the frame, a side of the annular fixing member away from the diaphragm being supported on the annular table surface. The frame is recessed in the annular table surface to form a first annular adhesive groove, the first annular adhesive groove is configured to hold a fixing adhesive, and the annular fixing member covers the first annular adhesive groove.

In some embodiments, the frame is recessed in the annular table surface to form a second annular adhesive groove, the second annular adhesive groove encloses the first annular adhesive groove, the second annular adhesive groove further connects to an outer peripheral wall of the frame connected to the annular table surface, the annular fixing member covers the second annular adhesive groove, and the second annular adhesive groove is visible from the outer peripheral wall of the frame.

In some embodiments, the frame is further provided with an annular flange connected to an inner side of the annular table surface, and the first annular adhesive groove is located at a junction of the annular flange and the annular table surface.

The present disclosure provides an air conduction speaker, comprising: a magnet assembly including a magnetic conduction shield, a magnet, and a magnetic conduction plate; a diaphragm; and a voice coil. The magnet and the magnetic conduction plate are stacked and arranged in a preset vibration direction, the magnetic conduction shield surrounds the magnet and the magnetic conduction plate, a magnetic gap extending along the preset vibration direction is formed among the magnetic conduction shield, the magnet, and the magnetic conduction plate, and a ratio of a thickness of the magnetic conduction plate to a thickness of the magnet in the preset vibration direction is in a range of 0.1˜1. The diaphragm is disposed opposite to the magnet assembly in the preset vibration direction. One end of the voice coil is fixedly connected to the diaphragm, and another end of the voice coil extends into the magnetic gap.

In some embodiments, the ratio of the thickness of the magnetic conduction plate to the thickness of the magnet in the preset vibration direction is in a range of 0.2˜0.9, or in a range of 0.3˜0.8.

In some embodiments, the magnetic conduction shield includes a cylindrical side plate and a base plate, the cylindrical side plate is connected to an outer peripheral edge of the base plate, the cylindrical side plate surrounds the magnet and the magnetic conduction plate, the magnetic conduction plate and the base plate are disposed on opposite sides of the magnet in the preset vibration direction, the magnetic conduction plate is closer to the diaphragm than the magnet, and a ratio of a thickness of the base plate to the thickness of the magnet in the preset vibration direction is in a range of 0.1˜0.9.

In some embodiments, the ratio of the thickness of the base plate to the thickness of the magnet in the preset vibration direction is in a range of 0.2˜0.8, or in a range of 0.3˜0.7.

In some embodiments, the magnetic conduction plate is provided with a first through-hole along the preset vibration direction; and/or the base plate is provided with a second through-hole along the preset vibration direction.

In some embodiments, a center of the first through-hole and a center of the second through-hole are collinear in the preset vibration direction; and/or a projection of the first through-hole on the base plate along the preset vibration direction falls within the second through-hole.

In some embodiments, the cylindrical side plate and the base plate are integrally molded, and a thickness of the cylindrical side plate is the same as a thickness of the base plate.

In some embodiments, a thickness of the magnet is within a range from 0.5 mm to 3 mm, or within a range from 0.9 mm to 2.5 mm; and/or a thickness of the magnetic conduction plate is within a range from 0.3 mm to 1.7 mm.

In some embodiments, the air conduction speaker includes a frame. The frame is connected to a periphery of the magnetic conduction shield, one end of the frame extends beyond the magnetic conduction shield in the preset vibration direction, and an outer peripheral edge of the diaphragm is fixed to one end of the frame. The frame is provided with an annular table surface. The air conduction speaker includes an annular fixing member, the annular fixing member is disposed between the annular table surface and the diaphragm, and fixedly connects the frame and the diaphragm. The frame is recessed in the annular table surface to form a first annular adhesive groove and a second annular adhesive groove, the first annular adhesive groove is configured to hold a fixing adhesive, the annular fixing member is supported on the annular table surface and covers the first annular adhesive groove, the second annular adhesive groove surrounds the first annular adhesive groove, the second annular adhesive groove further connects to an outer peripheral wall of the frame connected to the annular table surface, and the annular fixing member covers the second annular adhesive groove and makes the second annular adhesive groove to be visible from the outer peripheral wall of the frame.

The present disclosure provides a wearable electronic device, comprising a housing and an air conduction speaker as claimed in any one of claim 14 or claim 26, the air conduction speaker being provided in an interior of the housing.

In some embodiments, the wearable electronic device includes a bone conduction speaker, the bone conduction speaker being disposed in the interior of the housing and spaced apart from the air conduction speaker.

The beneficial effects of the present disclosure include that: the present disclosure provides a diaphragm including: a center main body and a folded ring. The folded ring is connected to an outer peripheral edge of the center main body. The folded ring includes two arcuate segments and two connecting segments, the two arcuate segments being spaced apart and disposed opposite to each other. The two connecting segments are disposed spaced apart side-by-side and connected one-to-one between two pairs of opposite ends of the two arcuate segments. Each arcuate segment is provided with a plurality of first pattern grooves spaced apart from each other in an extension direction of the arcuate segment, two ends of each first pattern groove extend towards an inner ring and an outer ring of the folded ring, respectively, and the plurality of first pattern grooves are arranged in a radial arrangement along a same spiral direction. By providing each arcuate segment with a plurality of first pattern grooves spaced apart from each other along an extension direction of the arcuate segment, and making two ends of each first pattern groove extend towards an inner ring and an outer ring of the folded ring, respectively, the first pattern grooves can provide circumferential cushioning around the diaphragm for the arcuate segments when the arcuate segments and the connecting segments undergo deformation, to slow down the stress generated when the arcuate segments undergo deformation, thereby effectively reducing the probability of elastic failure of the folded ring, effectively improving the working stability and working life of the diaphragm, and effectively improving the working life of the wearable electronic device. Furthermore, the plurality of first pattern grooves being arranged in the radial arrangement along the same spiral direction can be understood that the plurality of first pattern grooves are inclined along the same spiral direction, and a distance between two adjacent first pattern grooves is gradually enlarged along a radiation direction from the inner ring to the outer ring of the folded ring. Since when the diaphragm is vibrating in the preset vibration direction, the stress generated when the arcuate segment deforms has a circumferential stress, in the embodiments of the present disclosure, arranging the plurality of first pattern grooves in a radial arrangement along the same spiral direction can better mitigate the circumferential stress when deformation occurs, thereby further reducing the probability of elastic failure of the folded ring, and improving the working stability and working life of the diaphragm.

It should be understood that the above general description and the subsequent detailed description are only exemplary and explanatory, and not limiting of the present application.

### BRIEF DESCRIPTION OF THE DRAWINGS

In order to more clearly illustrate the technical solutions in the embodiments of the present disclosure, the accompanying drawings that need to be used in the description of the embodiments will be briefly introduced in the following, and it will be obvious that the accompanying drawings in the following description are only some of the embodiments of the application, and they will not be useful to a person of ordinary skill in the field without the effort of creativity. It is obvious that the following drawings are only some of the embodiments of the present disclosure, and for a person of ordinary skill in the art, other drawings can be obtained according to these drawings without creative labor.

FIG. 1 is a schematic diagram illustrating a generalized three-dimensional structure of a wearable electronic device according to some embodiments of the present disclosure;

FIG. 2 is a schematic diagram illustrating an exploded structure of a core assembly shown in FIG. 1;

FIG. 3 is a schematic diagram illustrating an exploded structure of an air conduction speaker shown in FIG. 2;

FIG. 4 is a schematic diagram illustrating a cross-sectional structure of an air conduction speaker shown in FIG. 2;

FIG. 5 is a schematic diagram illustrating a front view structure of a diaphragm shown in FIG. 3;

FIG. 6 is a schematic diagram illustrating an enlarged structure of a portion D of the diaphragm shown in FIG. 5;

FIG. 7 is a schematic diagram illustrating an enlarged structure of the portion D in a direction E of the diaphragm shown in FIG. 6;

FIG. 8 is a schematic diagram illustrating an enlarged structure of a portion A of the air conduction speaker shown in FIG. 4;

FIG. 9 is a schematic diagram illustrating an enlarged structure of a portion B of the air conduction speaker shown in FIG. 4; and

FIG. 10 is a schematic diagram illustrating an enlarged structure of a portion C of the air conduction speaker shown in FIG. 4.

### DETAILED DESCRIPTION

In order to enable those skilled in the art to better understand the technical solutions of the present disclosure, the charging box provided herein is described in further detail below in conjunction with the accompanying drawings and specific embodiments. It is to be understood that the described embodiments are only a part of the embodiments of the present disclosure, and not all of them. Based on the embodiments in the present disclosure, all other embodiments obtained by a person of ordinary skill in the art without making creative labor fall within the scope of protection of the present disclosure.

The terms “first,” “second,” and the like in the present disclosure are used to differentiate between different objects, and are not used to describe a particular order. Additionally, the terms “including” and “having,” as well as any variations thereof, are intended to cover non-exclusive objects. For example, a process, method, system, product, or apparatus that includes a series of steps or units is not limited to the listed steps or units, but optionally also includes steps or units that are not listed, or optionally also includes other steps or units inherent to those processes, methods, products, or devices.

The present disclosure provides a wearable electronic device 100. The wearable electronic device may include wearable electronic devices such as a headset, smart glasses, etc. Hereinafter, the present disclosure uses an earphone as an example of the wearable electronic device to describe the exemplary structure of wearable electronic device 100.

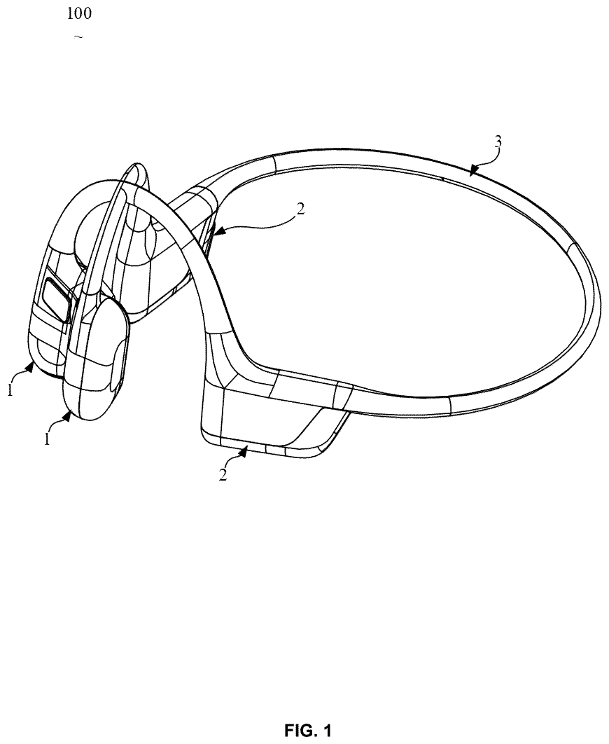

In some embodiments, as shown in FIG. 1, the wearable electronic device 100 may include a core assembly 1, an ear hook assembly 2, and a rear hook assembly 3. The count of core assemblies 1 may be two. The two core assemblies 1 are used to transmit vibration and/or sound to a left ear and a right ear of a user, respectively. The two core assemblies 1 may be the same or different. For example, one core assembly 1 may be provided with a microphone, and the other core assembly 1 may not be provided with a microphone. As another example, one core assembly 1 may be provided with a key and a corresponding circuit board, and another core assembly 1 may not be provided with a key and a corresponding circuit board. The two core assemblies 1 may be identical on a core module (e.g., a speaker module). The core assemblies 1 described subsequently herein may be considered to be described in detail as examples of one of the two core assemblies 1. The count of ear hook assemblies 2 may be two, and the two ear hook assemblies 2 may be located at the left ear and the right ear of the user, respectively, so as to enable the core assemblies 1 to be fitted to a face of the user. For example, one of the ear hook assemblies 2 may be provided with a battery, and the other ear hook assembly 2 may be provided with a control circuit, or the like. One end of the ear hook assembly 2 is connected to the core assembly 1, and the other end of the ear hook assembly 2 is connected to the rear hook assembly 3. The rear hook assembly 3 connects the two ear hook assemblies 2, and the rear hook assembly 3 is used to wrap around a neck back or a back head of the user to provide a clamping force, so that the two core assemblies 1 are clamped on both sides of the face of the user and the ear hook assemblies 2 are more securely attached to ears of the user. In some embodiments, the wearable electronic device 100 may also not include the rear hook assembly 3, the core assembly 1 is worn on the ear of the user via the ear hook assembly 2.

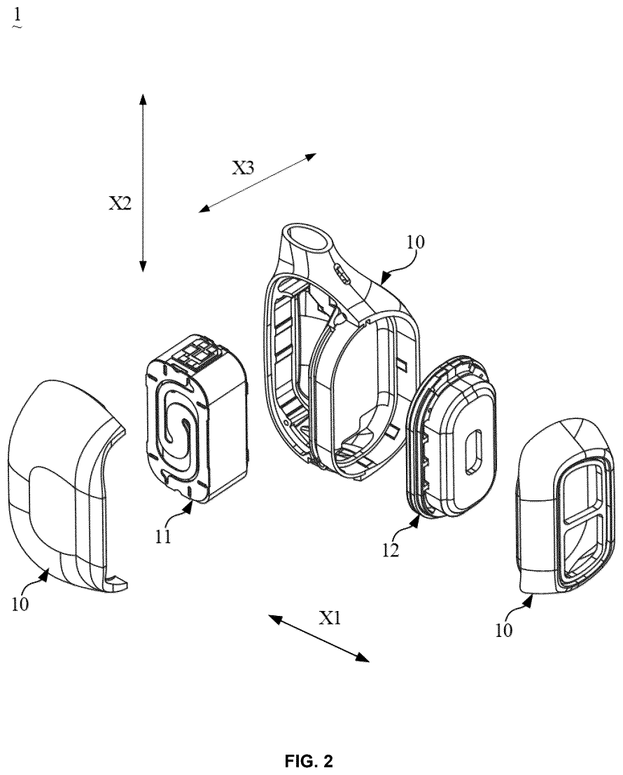

Optionally, as shown in FIG. 2, in some embodiments, the core assembly 1 includes a housing 10, an air conduction speaker 12, and a bone conduction speaker 11. The air conduction speaker 12 and the bone conduction speaker 11 are provided inside the housing 10, and the air conduction speaker 12 and the bone conduction speaker 11 are spaced apart. Based on this, the core assembly 1, including the air conduction speaker 12 and the bone conduction speaker 11 disposed simultaneously inside the housing 10, can effectively enhance the sound quality of the wearable electronic device. In addition, the bone conduction speaker 11 and the air conduction speaker 12 are spaced from each other, so that the bone conduction speaker 11 and the air conduction speaker 12 can effectively prevent mutual interference between the bone conduction speaker 11 and the air conduction speaker 12, thereby effectively enhancing the sound quality of the wearable electronic device 100.

Optionally, in some embodiments, the core assembly 1 may not have the bone conduction speaker 11, and only the air conduction speaker 12 may be provided in the housing 10, which will not be discussed in detail herein.

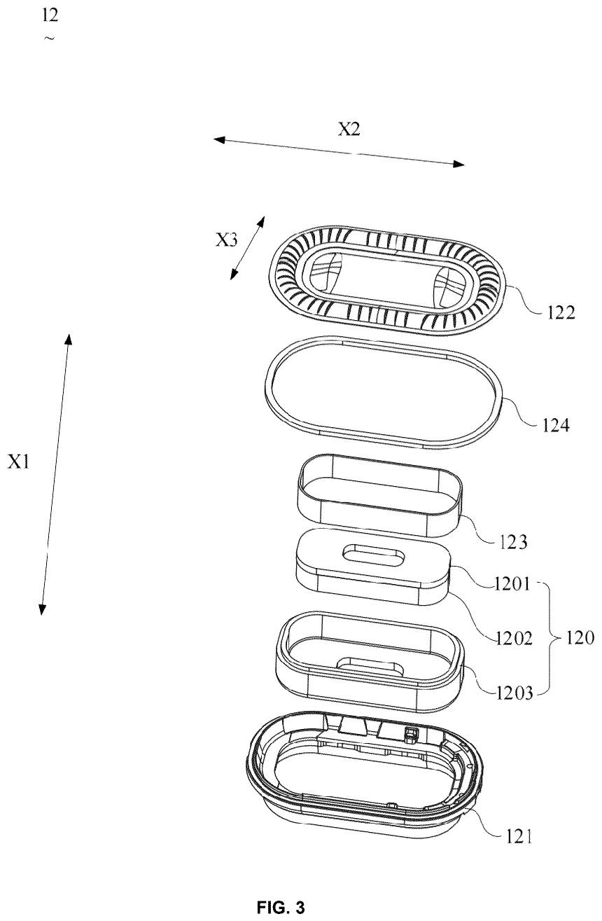

The present disclosure also proposes an air conduction speaker 12, as shown in FIG. 2-FIG. 4, the air conduction speaker 12 is used in the wearable electronic device of any of the above embodiments. The air conduction speaker 12 may be applied to any other wearable electronic device that is not provided with the bone conduction speaker 11. The present disclosure mainly focuses on the application of the air conduction speaker 12 in the aforementioned wearable electronic device to elaborate on the features of the air conduction speaker 12.

As shown in FIG. 2-FIG. 4, the air conduction speaker 12 includes a magnet assembly 120, a frame 121, a diaphragm 122, and a voice coil 123. The magnet assembly 120 is provided with a magnetic gap 201 extending along a preset vibration direction X1. The frame 121 is fixedly enclosed around the periphery of the magnet assembly 120. An outer peripheral edge of the diaphragm 122 is fixed to the frame 121 and disposed opposite to the magnet assembly 120; o. One end of the voice coil 123 is fixedly connected to the diaphragm 122, and another end of the voice coil 123 extends into the magnetic gap 20. A lower surface of the diaphragm 122 toward the magnet assembly 120 has a connecting position 202 connected to one end of the voice coil 123. The magnet assembly 120 has a top surface 203 toward the diaphragm 122 along the preset vibration direction X1. The diaphragm 122 has a longest dimension L1 in a direction perpendicular to the preset vibration direction X1. In a natural stationary state, there is a first spacing dimension L2 between the connecting position 202 and the top surface 203 in the preset vibration direction X1, and a ratio of the first spacing dimension L2 to the longest dimension L1 is in a range of 0.1 to 0.2.

Specifically, one end of the voice coil 123 is connected to the connecting position 202 of the diaphragm 122, and the other end of the voice coil 123 extends into the magnetic gap 201. The outer peripheral edge of the diaphragm 122 is fixedly connected to the frame 121, and the voice coil 123 acts inductively with the magnet assembly 120, thereby driving the diaphragm 122 to vibrate along the preset vibration direction X1. The magnet assembly 120 has the top surface 203 facing the diaphragm 122 along the preset vibration direction X1, and in a natural state, the ratio of the longest dimension L1 of the diaphragm 122 to the first spacing dimension L2 is set between 0.06-0.2, so that a relationship between a size of the diaphragm 122 and a vibration space of the voice coil 123 along the preset vibration direction X1 can be effectively coordinated to obtain the diaphragm 122 of an optimal size as well as the vibration space, thereby effectively enhancing the vibration effect of the diaphragm 122, and effectively enhancing the sound quality of the air conduction speaker 12. For example, in some embodiments, the longest dimension L1 is set to 18 mm, and the first spacing dimension L2 is set to 1.16 mm. On this configuration, it is possible to make the diaphragm 122 have a larger size to enhance the sound quality of the air conduction speaker 12, and reserve a sufficiently large vibration space for the voice coil 123 along the preset vibration direction X1, thereby effectively preventing the diaphragm 122 from colliding with the magnet assembly 120 to result in a loss of sound quality.

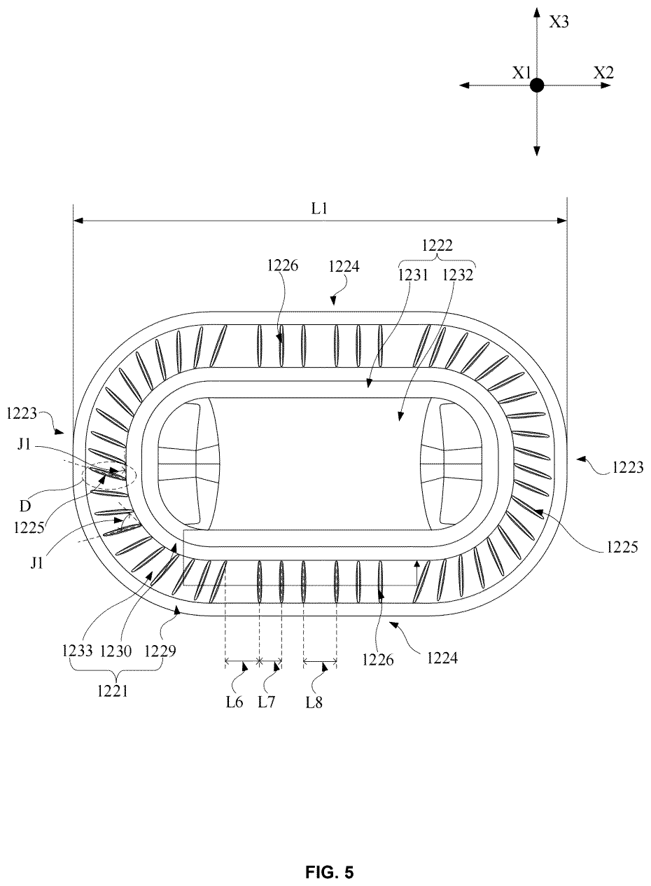

Optionally, as shown in FIG. 5, the diaphragm 122 is provided in a runway shape having a long axis direction X2 and a short axis direction X3 perpendicular to each other. The diaphragm 122 has the longest dimension L1 along the long axis direction X2. Specifically, in some embodiments, a planar structure of the diaphragm 122 is set as the runway shape. In some embodiments, the diaphragm 122 having the planar structure of the runway shape is also referred to as a runway-shaped diaphragm. The long axis direction X2 is a direction parallel to the connecting segment 1224, and the short axis direction X3 is a direction perpendicular to the connecting segment 1224. More descriptions may be found in related descriptions below, which will not be described in detail herein. In other embodiments, the diaphragm 122 may also be provided in other shapes, for example, a square shape, a round shape, etc.

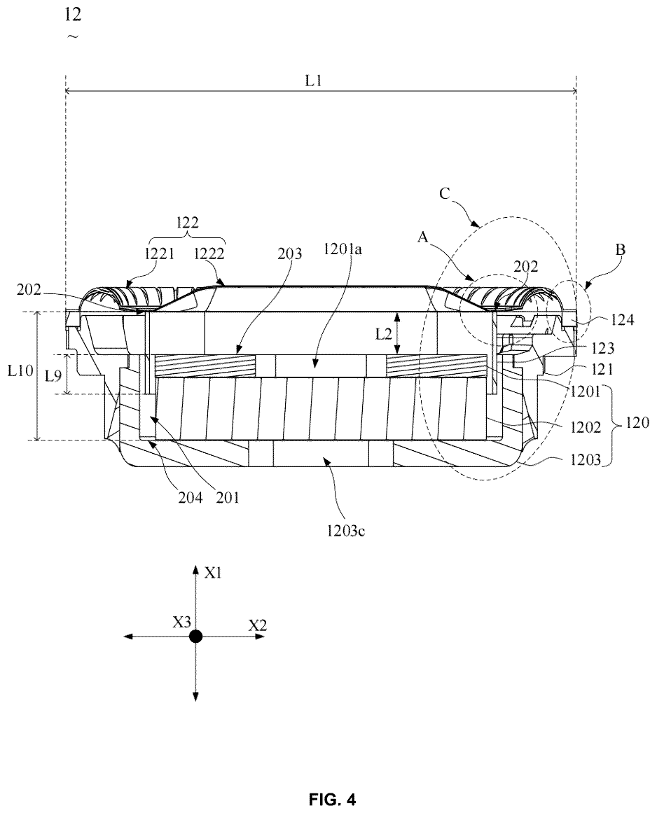

Optionally, as shown in FIG. 4-FIG. 5, the diaphragm 122 includes a center main body 1222 and a folded ring 1221. The folded ring 1221 is connected to an outer peripheral edge of the center main body 1222. The folded ring 1221 includes two arcuate segments 1223 and two connecting segments 1224. The two arcuate segments 1223 are spaced apart and disposed opposite to each other. The two connecting segments 1224 are disposed spaced apart side-by-side and connected one-to-one between two pairs of opposite ends of the two arcuate segments 1223. Each arcuate segment 1223 of the two arcuate segments 1223 is provided with a plurality of first pattern grooves 1225 spaced apart from each other in an extension direction of the arcuate segment 1223. Two ends of each first pattern groove 1225 extend towards an inner ring and an outer ring of the folded ring 1221, respectively; and the plurality of first pattern grooves 1225 are arranged in a radial arrangement along the same spiral direction.

Specifically, the diaphragm 122 serves as the diaphragm 122 of the air conduction speaker 12, which vibrates along the preset vibration direction X1 to realize sound generation. The folded ring 1221 includes two arcuate segments 1223 and two connecting segments 1224. The arcuate segments 1223 and the connecting segments 1224 deform (e.g., deformation due to extrusion) with the vibration of the diaphragm 122 along the preset vibration direction X1. Each arcuate segment is provided with the plurality of first pattern grooves 1225 spaced apart from each other in the extension direction of the arcuate segments 1223, and two ends of each first pattern groove 1225 extend towards the inner ring and the outer ring of the folded ring 1221, respectively. Based on the above structure, the first pattern grooves 1225 can provide circumferential cushioning around the diaphragm 122 for the arcuate segments 1223 when the arcuate segments 1223 and the connecting segments 1224 undergo deformation, to slow down the stress generated when the arcuate segments 1223 undergo deformation, thereby effectively reducing the probability of elastic failure of the folded ring 1221, effectively improving the working stability and working life of the diaphragm 122, and effectively improving the working life of the wearable electronic device. Further, the plurality of first pattern grooves 1225 being arranged in the radial arrangement along the same spiral direction can be understood that the plurality of first pattern grooves 1225 are inclined along the same spiral direction, and a distance between two adjacent first pattern grooves 1225 is gradually enlarged along a radiation direction from the inner ring to the outer ring of the folded ring 1221. When the diaphragm 122 is vibrating in the preset vibration direction X1, the stress generated when the arcuate segment 1223 deforms has a circumferential stress. In the embodiments of the present disclosure, arranging the plurality of first pattern grooves 1225 in a radial arrangement along the same spiral direction can better mitigate the circumferential stress when deformation occurs, thereby further reducing the probability of elastic failure of the folded ring 1221, and improving the working stability and working life of the diaphragm 122.

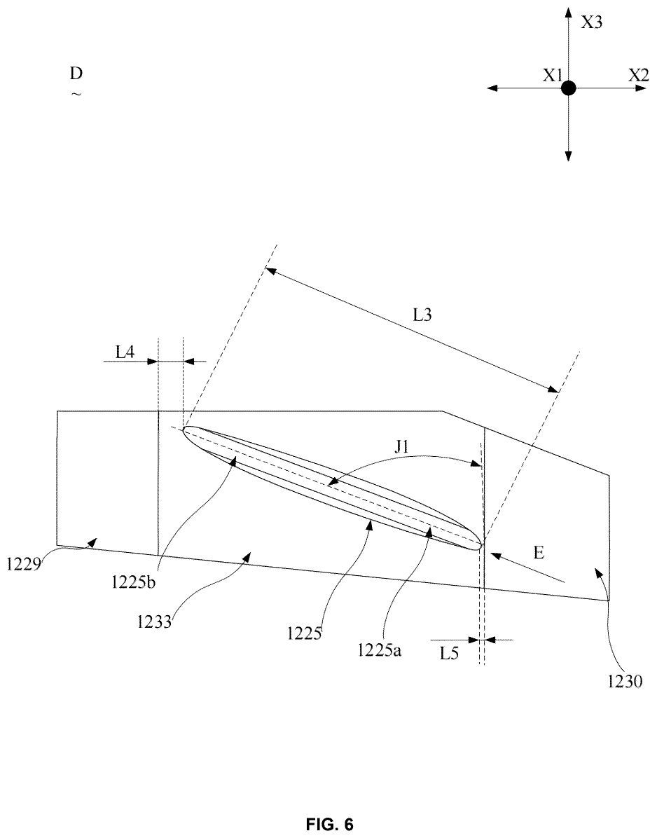

Optionally, as shown in FIG. 4-FIG. 6, in some embodiments, the folded ring 1221 has a long axis direction X2 and a short axis direction X3 perpendicular to each other. The two connecting segments 1224 extend along the long axis direction X2 and are spaced apart along the short axis direction X3. On a reference plane defined by the long axis direction X2 and the short axis direction X3, each first pattern groove 1225 has a first projection, and an inner edge of the folded ring 1221 has a second projection. The second projection and an extension line of the first projection have an intersection point on the reference plane. At the intersection point, an angle J1 between the extension line of the first projection and a tangent line of the second projection is greater than or equal to 30° and less than 90°. Specifically, the inner edge of the folded ring 1221 refers to an edge of the inner ring of the folded ring 1221. The first projection of the first pattern groove 1225 on the reference plane defined by the long axis direction X2 and the short axis direction X3 intersects with the second projection of the inner edge of the folded ring 1221 on the reference plane, and the angle J1 between the extension line of the first projection and the tangent line of the second projection is greater than or equal to 30° and less than 90°. Based on the above structure, the first pattern grooves 1225 can be arranged in the radial arrangement along the same spiral direction on the arcuate segments 1223 of the folded ring 1221, thereby effectively reducing the probability of elastic failure of the folded ring 1221, improving the working stability and working life of the diaphragm 122, and effectively improving the working life of the wearable electronic device.

Optionally, as shown in FIG. 4-FIG. 6, in some embodiments, the angle J1 corresponding to the first pattern groove 1225 decreases gradually along a direction from a middle point of the arcuate segment 1223 towards two ends of the arcuate segment 1223. The closer the first pattern groove 1225 is to the middle point of the arcuate segment 1223, the larger the corresponding angle J1; and the closer the first pattern groove 1225 is to two ends of the arcuate segment 1223, the smaller the corresponding angle J1. Based on the above structure, it is possible to make the first pattern grooves 1225 efficiently adapt to deformation directions at different positions of the arcuate segment 1223 when the arcuate segment 1223 deforms, so that the first pattern grooves 1225 can more efficiently mitigate the stresses during deformation.

Optionally, as shown in FIG. 4-FIG. 6, in some embodiments, the folded ring 1221 includes an inner ring folded edge 1230, an outer ring folded edge 1229, and an annular curved portion 1233 connected between the inner ring folded edge 1230 and the outer ring folded edge 1229. The annular curved portion 1233 is connected between the inner ring folded edge 1230 and the outer ring folded edge 1229. The inner ring folded edge 1230 is connected to the center main body 1222, and the plurality of first pattern grooves 1225 are opened in the annular curved portion 1233 and located in the annular curved portion 1233 at positions corresponding to the two arcuate segments 1223. Each first pattern groove 1225 has a first end 1225a proximate to the inner ring folded edge 1230 and a second end 1225b proximate to the outer ring folded edge 1229. A distance L5 between the first end 1225a and the inner ring folded edge 1230 is less than a distance L4 between the second end 1225b and the outer ring folded edge 1229.

Specifically, the inner ring folded edge 1230 is a structure formed by bending the inner ring of the folded ring 1221 with respect to the annular curved portion 1233 and extending inwardly, which is used as a part for connecting to the center main body 1222. The outer ring folded edge 1229 is a structure formed by bending the outer ring of the folded ring 1221 with respect to the annular curved portion 1233 and extending outwardly, which is used as a part for connecting to other components (i.e., the frame 121) in the air conduction speaker 12. The outer ring folded edge 1229 of the diaphragm 122 is the outer peripheral edge of the diaphragm 122 as set forth in the foregoing. The annular curved portion 1233 is a main part of the folded ring 1221 that provides elasticity to the diaphragm 122, and the deformation of the annular curved portion 1233 is particularly pronounced when the diaphragm 122 is vibrating along the preset vibration direction X1. The plurality of first pattern grooves 1225 are provided in the annular curved portion 1233 and are located at positions of the annular curved portion 1233 corresponding to the arcuate segments 1223. Based on this configuration, by providing the first pattern grooves 1225 in the annular curved portion 1233, the stress during deformation can be more effectively eliminated, thereby further reducing the probability of elastic failure of the folded ring 1221, and improving the working stability and working life of the diaphragm 122. The distance L5 between the first end 1225a and the inner ring folded edge 1230 is smaller than the distance L4 between the second end 1225b and the outer ring folded edge 1229, it means that the first pattern grooves 1225 are set at a position on the annular curved portion 1233 that is closer to the inner ring folded edge 1230, or the first pattern grooves 1225 are extended to a position closer to the inner ring folded edge 1230 when setting the first pattern grooves 1225 on the annular curved portion 1233. Based on this configuration, the first pattern grooves 1225 are provided at a part of the annular curved portion 1233 that has a larger deformation (i.e., a part of the annular curved portion 1233 that is close to the inner ring folded edge 1230), so that the first pattern grooves 1225 mitigate the stress during the deformation of the folded ring 1221 more effectively, thereby reducing the probability of the elastic failure of the folded ring 1221, and improving the working stability and working life of the diaphragm 122.

Optionally, a depth of each first pattern groove 1225 decreases gradually towards the two ends of the first pattern groove 1225, and a width of a groove opening of the first pattern groove 1225 decreases gradually towards the two ends of the first pattern groove 1225. Specifically, since the deformation (e.g., deformation caused by extrusion) of the annular curved portion 1233 along a middle portion of a radial direction is relatively large when the folded ring 1221 undergoes deformation, the depth of the first pattern groove 1225 becomes smaller at the two ends of the first pattern groove 1225, and the width of the first pattern groove 1225 becomes smaller at the two ends of the first pattern groove 1225. Based on the structure above, a structure of the first pattern groove 1225 effectively adapts to the deformation of the annular curved portion 1233, and effectively alleviates the deformation of the annular curved portion 1233, so as to play an effective buffering effect and effectively protect the elasticity of the folded ring 1221, thereby effectively reducing the probability of the elastic failure of the folded ring 1221, and enhancing the working stability and working life of the diaphragm 122.

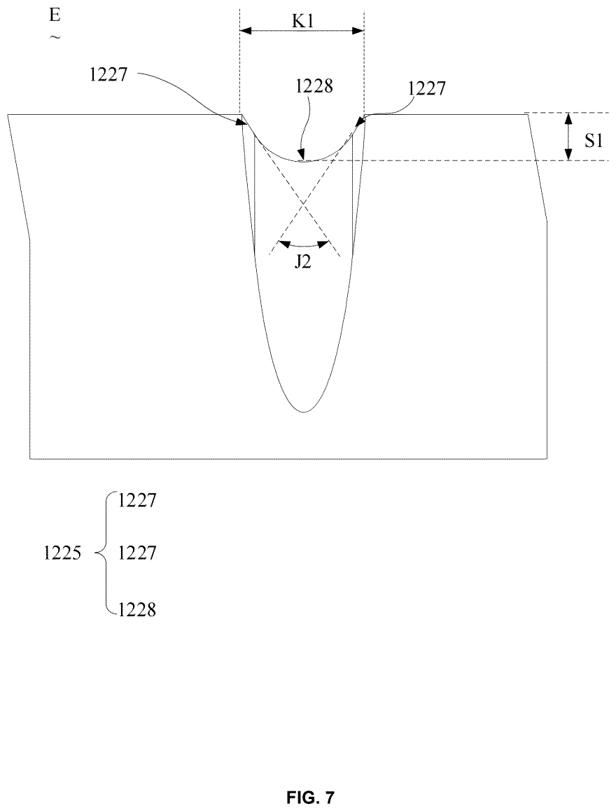

Optionally, as shown in FIG. 7, in some embodiments, a maximum depth S1 of the first pattern groove 1225 is in a range of 0.06 mm to 0.1 mm, and a maximum width K1 of the groove opening of the first pattern groove 1225 is in a range of 0.14 mm to 0.18 mm. Optionally, in some embodiments, the maximum depth S1 of the first pattern groove 1225 is located at the middle portion of the annular curved portion 1233 along the radial direction of the annular curved portion 1233, and the maximum width K1 of the groove opening of the first pattern groove 1225 is located at the middle portion of the annular curved portion 1233 along the radial direction of the annular curved portion 1233 and at a surface of the annular curved portion 1233.

Optionally, in some embodiments, a ratio of a depth of each first pattern groove 1225 at any one position to a width of a groove opening of the first pattern groove 1225 at that position is in a range of 0.5 to 4.

Optionally, in some embodiments, a groove wall of each first pattern groove 1225 includes a curved bottom wall 1228 and two side walls 1227 disposed opposite to each other. The curved bottom wall 1228 is connected between the two side walls 1227 and is disposed in a curved depression in a direction away from a groove opening of the first pattern groove 1225, and the curved bottom wall 1228 and the two side walls 1227 are smoothly connected. Based on this, the curved bottom wall 1228 and the two side walls 1227 disposed opposite to each other form the above-mentioned first pattern groove 1225 through the above-mentioned positional relationship.

Optionally, as shown in FIG. 7, in some embodiments, an angle J2 between the two side walls 1227 is in a range of 50° to 120°, or a range of 60° to 100°. Based on the structure above, it can be ensured that there is a large cushioning space between the two side walls 1227, and the first pattern groove 1225 can effectively adapt to the deformation of the folded ring 1221, thereby effectively protecting the elasticity of the folded ring 1221, thereby effectively reducing the probability of elastic failure of the folded ring 1221, and improving the working stability and working life of the diaphragm 122.

Optionally, as shown in FIG. 5, in some embodiments, the plurality of first pattern grooves 1225 of the two arcuate segments 1223 have the same spiral direction. Based on the structure above, the first pattern grooves 1225 on the two arcuate segments 1223 are able to adapt to the deformation of the folded ring 1221, thereby protecting the elasticity of the folded ring 1221 more effectively, effectively reducing the probability of elastic failure of the folded ring 1221, and improving the working stability and working life of the diaphragm 122.

Optionally, as shown in FIG. 5, in some embodiments, at least one of the two connecting segments 1224 is provided with a plurality of second pattern grooves 1226 spaced apart from each other. Two ends of each second pattern groove 1226 extend towards the inner ring and outer ring of the folded ring 1221, respectively. Specifically, the second pattern grooves 1226 can effectively slow down the deformation of the folded ring 1221 at the connecting segments 1224, thereby further reducing the probability of elastic failure of the folded ring 1221, and improving the working stability and working life of the diaphragm 122. In some embodiments, the two connecting segments 1224 are both provided with the second pattern grooves 1226 described above. In some other embodiments, the second pattern grooves 1226 may be provided at only one of the two connecting segments 1224. Optionally, in some embodiments, a specific structure of the second pattern groove 1226 may be the same as a specific structure of the first pattern groove 1225, and more descriptions may be found in related descriptions above, and will not be described in detail herein. In some other embodiments, the second pattern groove 1226 may adopt other structural forms, which are not described in detail herein.

Optionally, as shown in FIG. 5, as set forth above, the folded ring 1221 has the long axis direction X2 and the short axis direction X3 perpendicular to each other, the two connecting segments 1224 extend along the long axis direction X2 and are spaced apart along the short axis direction X3. An angle between the short axis direction X3 and an extension direction of the projection of the second pattern groove 1226 on the reference plane defined by the long axis direction X2 and the short axis direction X3 is less than 5°. Specifically, in some embodiments, the angle between the short axis direction X3 and an extension direction of the projection of the second pattern groove 1226 on the reference plane defined by the long axis direction X2 and the short axis direction X3 generally does not exceeds 5°, i.e., the second pattern groove 1226 and the short axis direction X3 are basically provided in parallel. Based on the structure above, the second pattern groove 1226 can effectively adapt to the deformation of the connecting segment 1224, thereby effectively slowing down the deformation stress of the connecting segment 1224, more effectively protecting the elasticity of the folded ring 1221, effectively reducing the probability of the elastic failure of the folded ring 1221, and enhancing the working stability and working life of the diaphragm 122.

Optionally, as shown in FIG. 5, the plurality of second pattern grooves 1226 are divided into at least two groups of second pattern grooves 1226. In each group of second pattern grooves 1226, there is a first interval distance L7 between the two adjacent second pattern grooves 1226. There is a second interval distance L8 between two adjacent groups of second pattern grooves 1226. There is a third interval distance L6 between a second pattern groove 1226 of the second pattern grooves 1226 and a first pattern groove 1225 of the first pattern grooves 1225 that is closest to each other, and the first interval distance L7 is smaller than the third interval distance L6. For example, the plurality of second pattern grooves 1226 provided on the connecting segments 1224 are divided into several groups. The second pattern grooves 1226 in each group are uniformly arranged at the first interval distance L7 in a portion of the connecting segment 1224 that deforms severely, while two groups of second pattern grooves 1226 are separated by the second interval distance L8 in a portion of the connecting segment 1224 that deforms weakly, so that the second pattern groove 1226 can effectively adapt to the deformation of the connecting segments 1224. For example, since the deformation of the connecting segment 1224 mainly occurs at the two ends thereof, in this embodiment, the plurality of second pattern grooves 1226 are divided into two groups. The two groups of second pattern grooves 1226 are symmetrically spaced apart at the two ends of the connecting segment 1224 by the second interval distance L8 in the long axis direction X2, so that the second pattern grooves 1226 can effectively adapt to the deformation of the connecting segment 1224. Further, since the second interval distance L8 is a spacing distance between two adjacent groups of the second pattern grooves 1226, and the third interval distance L6 is a spacing distance between the first pattern groove 1225 and the corresponding adjacent second pattern groove 1226, setting the first interval distance L7 to be smaller than the second interval distance L8 and smaller than the third interval distance L6 can effectively enhance the ability of the connecting segment 1224 to cushion the deformation, while ensuring the connecting segment 1224 to have sufficiently strength, thereby reducing the deformation of the connecting segment 1224.

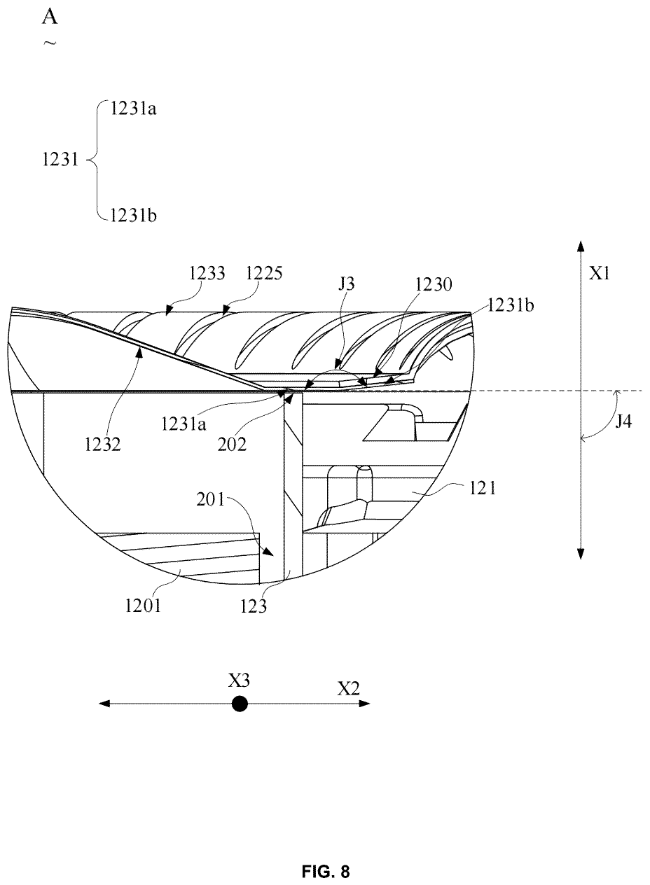

Optionally, as shown in FIG. 4 and FIG. 8, in some embodiments, as set forth above, the diaphragm 122 includes the folded ring 1221 and the center main body 1222. The folded ring 1221 includes the inner ring folded edge 1230 and the outer ring folded edge 1229. The outer ring folded edge 1229 surrounds the inner ring folded edge 1230. The outer ring folded edge 1229 is fixed with respect to the frame 121. The center main body 1222 includes a main body portion 1232 and an annular connecting edge 1231 connected to an outer peripheral edge of the main body portion 1232. The inner ring folded edge 1230 and the annular connecting edge 1231 are connected in a layered manner. The connecting position 202 is located on a lower surface of one of the inner ring folded edge 1230 and the annular connecting edge 1231, which is close to the voice coil 123 and faces the voice coil 123, and an angle J4 between the lower surface where the connecting position 202 is located and the preset vibration direction X1 is greater than or equal to 80° and less than or equal to 90°.

Specifically, the diaphragm 122 includes the folded ring 1221 and the center main body 1222. The folded ring 1221 includes the inner ring folded edge 1230 and the outer ring folded edge 1229, which surrounds the inner ring folded edge 1230. The center main body 1222 includes the main body portion 1232 and the annular connecting edge 1231, which is connected to the outer peripheral edge of the main body portion 1232. The inner ring folded edge 1230 and the annular connecting edge 1231 are connected in a layered manner, so that a complete diaphragm 122 is formed. The connecting position 202 is located on a lower surface of one of the inner ring folded edge 1230 and the annular connecting edge 1231, which is close to the voice coil 123 and faces the voice coil 123, and the angle J4 between the lower surface where the connecting position 202 is located and the preset vibration direction X1 is in a range of 80°˜90°, so that an inclination degree of the lower surface where the connecting position 202 is located with respect to the preset vibration direction X1 is small, thereby ensuring that there is a sufficient distance between the lower surface of the diaphragm 122 and the top surface 203 of the magnet assembly 120, i.e., ensuring that the first spacer dimension L2 is sufficiently large, thereby efficiently preventing the diaphragm 122 from colliding with the magnet assembly 120 to result in loss of sound quality. Optionally, in some embodiments, the diaphragm 122 includes the above-described constituent structures (i.e., the folded ring 1221 and the center main body 1222), the planar shape structure of the diaphragm 122 may be set to other shapes, such as a square shape, a circular shape, etc., which is not limited to the runway shape.

Optionally, as shown in FIG. 4 and FIG. 8, the annular connecting edge 1231 includes a first sub-connecting edge 1231a and a second sub-connecting edge 1231b. The first sub-connecting edge 1231a is connected around the main body portion 1232, and the second sub-connecting edge 1231b is connected around the first sub-connecting edge 1231a. The inner ring folded edge 1230 is stacked on the second sub-connecting edge 1231b, and the connecting position 202 is located at a lower surface of the second sub-connecting edge 1231b toward the voice coil 123. The first sub-connecting edge 1231a and the second sub-connecting edge 1231b are connected at an angle J3 within a range of 145°˜180°; and/or in the natural stationary state, an outer edge of the first sub-connecting edge 1231a connecting to the second sub-connecting edge 1231b is closer to the magnet assembly 120 along the preset vibration direction as compared to an inner edge of the first sub-connecting edge 1231a connecting to the main body portion 1232.

Specifically, the annular connecting edge 1231 includes the first sub-connecting edge 1231a and the second sub-connecting edge 1231b. The first sub-connecting edge 1231a surrounds the main body portion 1232 and is connected to the main body portion 1232. The second sub-connecting edge 1231b surrounds the first sub-connecting edge 1231a and is connected to the first sub-connecting edge 1231a. The first sub-connecting edge 1231a and the second sub-connecting edge 1231b are connected at an angle, and the angle J3 is in the range of 145° to 180°, so that the annular connecting edge 1231 presents a structure that slopes from both sides (the both sides of the annular connecting edge 1231 are the first sub-connecting edge 1231a and the second sub-connecting edge 1231b, respectively) towards the middle (the middle refers to a place where the first sub-connecting edge 1231a connects with the second sub-connecting edge 1231b), thereby effectively preventing a connecting adhesive (e.g., dispensing adhesive, etc.) at the connecting position 202 and a connecting adhesive (e.g., dispensing adhesive, etc.) of the second sub-connecting edge 1231b and the inner ring folded edge 1230 from overflowing to the main body portion 1232 to affect the vibration effect of the main body portion 1232, effectively enhancing the sound quality of the air conduction speaker 12. Optionally, in some embodiments, based on the above-described angle J3, the outer edge of the first sub-connecting edge 1231a connecting the second sub-connecting edge 1231b is closer to the magnet assembly 120 in the vibrational direction compared to the inner edge of the first sub-connecting edge 1231a connecting to the main body portion 1232, i.e., the connecting position 202 is located on the side of the first sub-connecting edge 1231a close to the second sub-connecting edge 1231b, so that it can effectively prevent the dispensing adhesive at the connecting position 202 from overflowing to the main body portion 1232 to affect the vibration effect of the main body portion 1232, thereby further enhancing the sound quality of the air conduction speaker 12.

Optionally, in some other embodiments, the above-mentioned angle J3 can be adjusted by limiting the positional relationship between the first sub-connecting edge 1231a and the second sub-connecting edge 1231b to prevent the dispensing adhesive and other substances from overflowing into the main body portion 1232. For example, the above-mentioned angle J3 is limited to be in the range of 145° to 180°, or the dispensing adhesive and other substances can also be prevented from overflowing into the main body portion 1232 by limiting the outer and inner edges of the first sub-connecting edge 1231a alone, such as by limiting the outer edge of the first sub-connecting edge 1231a connecting to the second sub-connecting edge 1231b to be closer to the magnet assembly 120 in the preset vibration direction X1 as compared to the inner edge of the first sub-connecting edge 1231a connecting to the main body portion 1232.

Optionally, as shown in FIG. 4 and FIG. 8, the annular connecting edge 1231 is bent in connection with the main body portion 1232, and the main body portion 1232 is arched in a direction away from the magnet assembly 120. An orthographic projection of a portion at a bent connection position between the annular connecting edge 1231 and the main body portion 1232 on a reference plane perpendicular to the preset vibration direction X1 falls within an orthographic projection of the magnetic gap 201 on the reference plane. Specifically, a projection of the portion at the bent connection position between the annular connecting edge 1231 and the main body portion 1232 along the preset vibration direction X1 falls into the magnetic gap 201, so that the bent connection position between the annular connecting edge 1231 and the main body portion 1232 can be effectively prevented from colliding with the magnetic assembly in the process of vibration of the diaphragm 122 along the preset vibration direction X1, which generate noises and affect the vibration effect of the diaphragm 122, thereby effectively improving the sound quality of the air conduction speaker 12. In some embodiments, the center main body 1222 may be a one-piece structure. The annular connecting edge 1231 is a portion formed by bending and extending the main body portion 1232. In some other embodiments, the center main body 1222 may be an assembled structure, i.e., the center main body 1222 consists of the annular connecting edge 1231 and the main body portion 1232 connected by gluing, which is not described in detail herein.

The diaphragm 122 set forth in any of the above-described embodiments may be applied to the air conduction speaker 12 of the above-described core assembly 1. In other embodiments, the diaphragm 122 set forth in any of the above-described embodiments may be applied to the air conduction speaker 12 of the core assembly 1 of other embodiments, or to the components that require the use of the diaphragm 122 for sound generation, which will not be described herein in detail.

Optionally, the magnet assembly 120 and the voice coil 123 form a drive assembly of the air conduction speaker 12 in the manner described above. The drive assembly is at least partially surrounded by the frame 121, i.e., the magnet assembly 120, the voice coil 123, etc., are surrounded by the frame 121. The drive assembly is coupled to the center main body 1222, i.e., the center main body 1222 as described above is coupled to the voice coil 123. Thus, the driver assembly may drive the diaphragm 122 to vibrate in the preset vibration direction X1. In other embodiments, the driver assembly may include other components, which are not described in detail herein.

Optionally, as shown in FIG. 4, the magnetic gap 201 is provided in an annular shape, the magnet assembly 120 includes a middle portion surrounded by the magnetic gap 201, and the top surface 203 is an upper surface of the middle portion facing the diaphragm 122. Specifically, the other end of the voice coil 123 extends into the magnetic gap 201, and there is a risk of collision between the middle portion and the diaphragm 122 when the voice coil 123 drives the diaphragm 122 to vibrate along the preset vibration direction X1. The top surface 203 is defined as the upper surface of the middle portion, i.e., by defining the relationship between the first spacing dimension L2 from the upper surface of the middle portion to the connecting position 202 and the longest dimension L1, it is possible to effectively prevent the diaphragm 122 from colliding with the middle portion to produce a noise and upgrade the dimension of the diaphragm 122 to a certain extent, thereby effectively improving the vibration effect of the diaphragm 122, effectively preventing noises from interfering, and effectively enhancing the sound quality of the air conduction speaker 12.

Optionally, as shown in FIG. 4, in some embodiments, the magnet assembly 120 includes a magnetic conduction shield 1203, a magnet 1202, and a magnetic conduction plate 120. The magnetic conduction shield 1203 is fixedly connected to the frame 121, the magnetic conduction shield 1203 encloses the magnet 1202 and the magnetic conduction plate 1201, and the magnetic conduction plate 1201 and the magnet 1202 are stacked. The magnetic conduction plate 1201 is closer to the diaphragm 122 than the magnet 1202, the magnet 1202 and the magnetic conduction plate 1201 serve as the middle portion, and the top surface 203 is an upper surface of the magnetic conduction plate 1201 facing the diaphragm 122. Specifically, the magnet assembly 120 includes the magnetic conduction shield 1203, the magnet 1202, and the magnetic conduction plate 1201. The magnetic conduction shield 1203 serves as a fixed connection between the magnet 1202 and the magnetic conduction plate 1201. The frame 121 is connected to a periphery of the magnetic conduction shield 1203, one end of the frame 121 extends beyond the magnetic conduction shield 1203 in the preset vibration direction X1, and an outer peripheral edge of the diaphragm 122 is fixed to one end of the frame 121 (i.e., the outer peripheral edge of the diaphragm 122 is fixed to the end of the frame 121 provided with the annular table surface 1241, more descriptions may be found in related descriptions below). A mounting groove is provided in the magnetic conduction shield 1203, the magnet 1202 and the magnetic conduction plate 1201 are stacked and provided in the mounting groove, and the magnetic conduction shield 1203 is fixedly connected to the frame 121. The magnet 1202 is an element for providing a magnetic field, the magnetic conduction plate 1201 is a component for adjusting magnetic induction lines of the magnetic field, and the magnetic conduction plate 1201 is disposed on the magnet 1202 along the preset vibration direction X1, so that the magnetic flux that passes through the voice coil 123 can be effectively increased, thereby effectively enhancing the sound quality of the air conduction speaker 12.

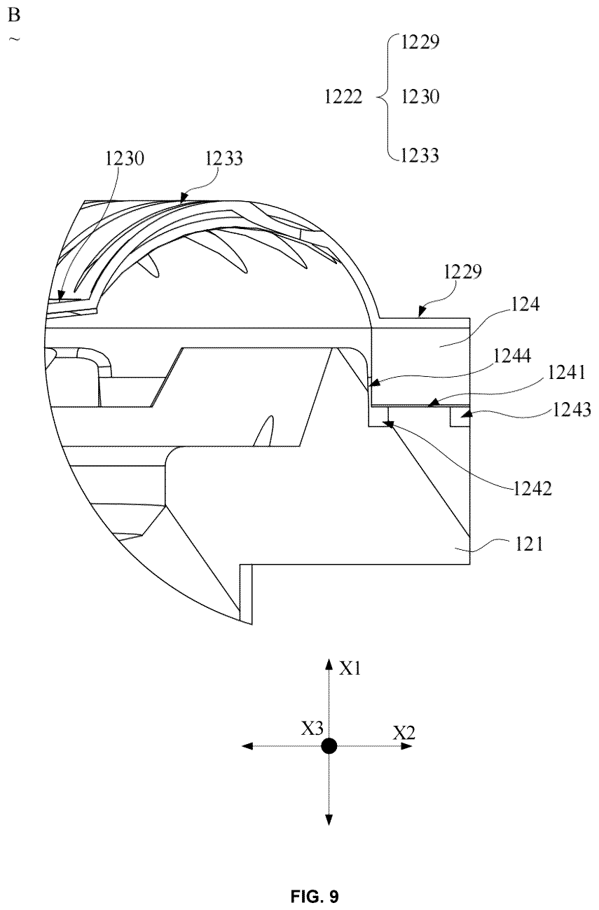

Optionally, as shown in FIG. 4 and FIG. 9, the frame 121 is provided with an annular table surface 1241. The air conduction speaker 12 includes an annular fixing member 124. The annular fixing member 124 is connected to a side of an outer edge of the diaphragm 122 facing the frame 121. A side of the annular fixing member 124 away from the diaphragm 122 is supported on the annular table surface 1241, so as to enable the diaphragm 122 to be more stably fixed to the frame 121 by the annular fixing member 124. The frame 121 is recessed in the annular table surface 1241 to form a first annular adhesive groove 1242. The first annular adhesive groove 1242 is configured to hold a fixing adhesive, and the annular fixing member 124 covers the first annular adhesive groove 1242. Specifically, the side of the outer edge of the diaphragm 122 facing the frame 121 is a side of the outer ring folded edge 1229 facing the frame 121. The side of the outer edge of the diaphragm 122 is connected to the annular table surface 1241 of the frame 121 by the annular fixing member 124, so that the annular fixing member 124 can effectively slow down the vibration of the diaphragm 122 transmitted to the frame 121, thereby effectively enhancing the vibration effect of the diaphragm 122. Specifically, in some embodiments, the annular table surface 1241 is fixed with the side of the annular fixing member 124 facing the annular table surface 1241 by fixing glue. Further, the annular table surface 1241 is further provided with the first annular adhesive groove 1242, which is used to accommodate the fixing glue. The fixing glue is accommodated in the first annular adhesive groove 1242, and the annular fixing member 124 and the frame 121 are further fixed by the fixing glue in the first annular adhesive groove 1242, so that a contact area between the fixing glue and the annular fixing member 124 or a contact area between the fixing glue and the frame 121, as well as the amount of the fixing glue, can be increased, thereby improving the stability of fixing between the annular fixing member 124 and the frame 121, improving the stability of fixing between the diaphragm 122 and the frame 121, and effectively preventing abnormal vibration of the diaphragm 122 due to unstable connection.

Optionally, as shown in FIG. 4 and FIG. 9, the frame 121 is further provided with an annular flange 1244 connected to an inner side of the annular table surface 1241, and the first annular groove is located at a junction of the annular flange 1244 and the annular table surface 1241. Specifically, the frame 121 is provided with the annular flange 1244, the annular flange 1244 is disposed on the inner side (i.e., the side close to the magnet assembly 120) of the annular table surface 1241, so that the annular flange can effectively limit the contraction of the annular fixing member 124 along the radial direction of the annular fixing member 124, and the annular flange can also serve as a barrier to the fixing glue in the first annular groove to prevent the fixing glue from overflowing onto the magnet assembly 120.

Optionally, as shown in FIG. 4 and FIG. 9, the frame 121 is recessed in the annular table surface 1241 to form a second annular adhesive groove 1243, the second annular adhesive groove 1243 encloses the first annular adhesive groove 1242, the second annular adhesive groove 1243 further connects to an outer peripheral wall of the frame 121 connected to the annular table surface 1241. The annular fixing member 124 covers the second annular adhesive groove 1243, and the second annular adhesive groove 1243 is visible from the outer peripheral wall of the frame 121. Specifically, the annular table surface 1241 is further recessed to form the second annular adhesive groove 1243, and the second annular adhesive groove 1243 surrounds the first annular adhesive groove 1242. After the fixing glue in the first annular adhesive groove 1242 overflows the annular table surface 1241, the excess fixing glue overflows into the second annular adhesive groove 1243, thereby effectively avoiding the excess fixing glue from overflowing onto the outer peripheral wall of the frame 121 and solidifying, affecting the overall structural size and weight of the frame 121, thereby effectively improving the assembly precision and stability of the air conduction speaker 12. Further, the second annular adhesive groove 1243 is provided at an edge position of the annular table surface 1241 near the outer peripheral wall the frame 121, i.e., the second annular adhesive groove 1243 is connected to the outer peripheral wall of the frame 121, so that the dimension (e.g., an area) of the annular table surface 1241 between the first annular adhesive groove 1242 and the second annular adhesive groove 1243 can be larger. The fixing glue added to the first annular adhesive groove 1242 overflows the entire annular table surface 1241 before overflowing to the second annular adhesive groove 1243, thereby effectively increasing the contact area between the annular table surface 1241 and the fixing glue, and effectively enhancing the stability of the connection with the diaphragm 122.

Optionally, as shown in FIG. 4, in the natural stationary state, a portion of the voice coil 123 extending between another end of the magnetic gap 201 and the top surface 203 has a second spacing dimension L9 in the preset vibration direction X1, and a ratio of the second spacing dimension L9 to the first spacing dimension L2 is in a range of 0.85 to 1.66. Based on the structure above, limiting the ratio of the second spacing dimension L9 to the first spacing dimension L2 in the range of 0.85 to 1.66 can effectively prevent the voice coil 123 from falling out of the magnetic gap during operation, thereby effectively improving the operating stability of the voice coil 123. For example, in some embodiments, the second spacing dimension L9 is set to 1.06 mm, and the ratio of the second spacing dimension L9 to the first spacing dimension L2 is 0.91, so that the voice coil 123 is effectively prevented from detaching from the magnetic gap 201 during operation.

Optionally, as in FIG. 4, the magnetic gap 201 has a gap bottom surface 204 away from the connecting position 202. In the natural stationary state, there is a third spacing dimension L10 between the connecting position 202 and the gap bottom surface 204 in the preset vibration direction X1, and a ratio of the third spacing dimension L10 to the longest dimension L1 is in a range 0.15 to 0.4. A position between the connecting position 202 and the gap bottom surface 204 is a position where the voice coil 123 is set, the longest dimension L1 of the diaphragm 122 affects the elasticity of the diaphragm 122, so that the third spacing dimension L10 and the longest dimension L1 of the diaphragm 122 can affect, to a certain extent, the vibration space of the voice coil 123 along the preset vibration direction X1 and the vibration effect of the diaphragm 122. In this embodiments, the ratio of the third spacing dimension L10 to the longest dimension L1 is limited to the range of 0.15 to 0.4, so that the diaphragm 122 of a more reasonable size can be obtained, and at the same time, the voice coil 123 can be ensured to have a larger vibration space, thereby effectively enhancing the vibration effect of the diaphragm 122, and effectively enhancing the sound quality of the air conduction speaker 12.

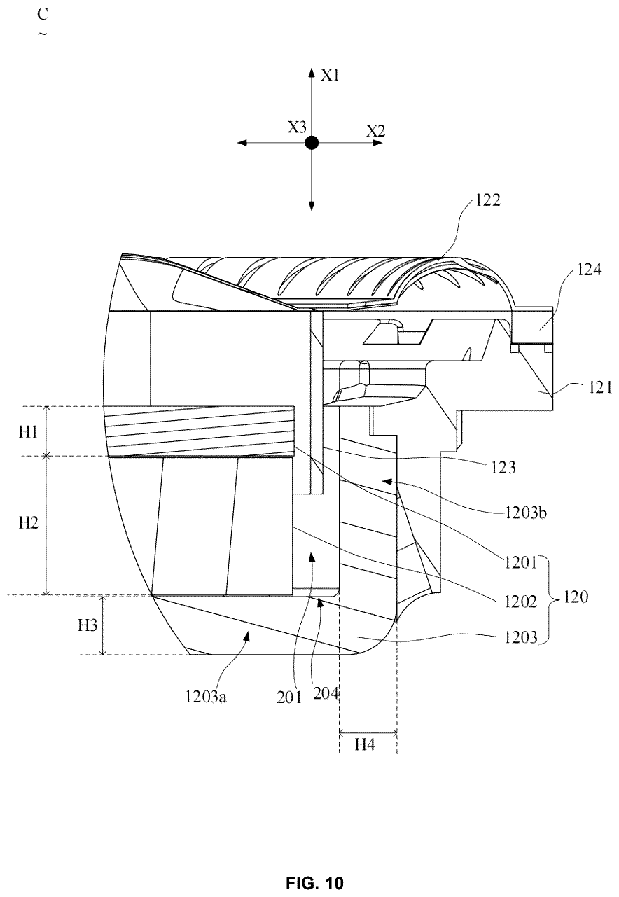

Optionally, as shown in FIG. 4 and FIG. 10, the magnetic conduction shield 1203 surrounds the magnet 1202 and the magnetic conduction plate 1201, and a magnetic gap extending along the preset vibration direction X1 is formed among the magnetic conduction shield 1203, the magnet 1202, and the magnetic conduction plate 1201. A ratio of a thickness of the magnetic conduction plate 1201 to a thickness of the magnet 1202 in the preset vibration direction X1 is in a range of 0.1 to 1. Specifically, as described above, the mounting groove is provided in the magnetic conduction shield 1203, the magnet 1202 and the magnetic conduction plate 1201 are stacked provided in the mounting groove, and the magnetic conduction shield 1203 is fixedly connected to the frame 121. The ratio of the thickness H1 of the magnetic conduction plate 1201 to the thickness H2 of the magnet 1202 is in the range of 0.1 to 1, so that the magnetic conductivity of the magnetic conduction plate 1201 to the magnet 1202 can be effectively enhanced to improve the magnetic flux passing through the voice coil 123 and the magnetic field strength, thereby effectively improving the vibration strength of the voice coil 123 under the condition that the power output remains unchanged, and effectively improving the sound quality effect of the air conduction speaker 12.

Optionally, as shown in FIG. 4 and FIG. 10, in some embodiments, the ratio of the thickness of the magnetic conduction plate 1201 and the thickness of the magnet 1202 in the preset vibration direction X1 is in a range of 0.2 to 0.9, or in a range of 0.3 to 0.8. In other words, the ratio of the thickness H1 of the magnetic conduction plate 1201 to the thickness H2 of the magnet 1202 is in a range of 0.2˜0.9, or in a range of 0.3˜0.8.

Optionally, as shown in FIG. 4 and FIG. 10, in some embodiments, a thickness H2 of the magnet 1202 is within a range from 0.5 to 3 mm, or within a range from 0.9 to 2.5 mm; and/or, a thickness H1 of the magnetic conduction plate 1201 is within a range from 0.3 mm to 1.7 mm.

Optionally, as shown in FIG. 4 and FIG. 10, the magnetic conduction shield 1203 includes a cylindrical side plate 1203b and a base plate 1203a, the cylindrical side plate 1203b is connected to an outer peripheral edge of the base plate 1203a, and the cylindrical side plate 1203b surrounds the magnet 1202 and the magnetic conduction plate 1201. The magnetic conduction plate 1201 and the base plate 1203a are disposed on opposite sides of the magnet 1202 in the preset vibration direction X1, the magnetic conduction plate 1201 is closer to the diaphragm 122 than the magnet 1202, and a ratio of a thickness of the base plate 1203a to the thickness of the magnet 1202 in the preset vibration direction X1 is in a range of 0.1 to 0.9. Specifically, in some embodiments, as set forth above, the magnetic conduction shield 1203 includes the cylindrical side plate 1203b and the base plate 1203a. The cylindrical side plate 1203b is attached to the outer peripheral edge of the base plate 1203a, and the cylindrical side plate 1203b surrounds the magnet 1202 and the magnetic conduction plate 1201. The magnetic conduction plate 1201 and the base plate 1203a are disposed on opposite sides of the magnet 1202 along the preset vibration direction X1, and the magnetic conduction plate 1201 is closer to the diaphragm 122 than the magnet 1202. The ratio of the thickness H3 of the base plate 1203a to the thickness H2 of the magnet 1202 is set in the range of 0.1 to 0.9, so that the effect of the floor on the magnetic conductivity of the magnet 1202 can be effectively enhanced, thereby improving the magnetic flux passing through the voice coil 123 and the strength of the magnetic field, so as to further enhance the vibrational intensity of the voice coil 123 under the condition that the power output remains unchanged, thereby further enhancing the sound quality effect of the air conduction speaker 12.

Optionally, as shown in FIG. 4 and FIG. 10, in some embodiments, the ratio of the thickness of the base plate 1203a to the thickness of the magnet 1202 in the preset vibration direction X1 is in a range of 0.2 to 0.8, or in a range of 0.3 to 0.7. In other words, the ratio of the thickness H3 of the base plate 1203a to the thickness H2 of the magnet 1202 is in a range of 0.2 to 0.8, or in a range of 0.3 to 0.7.

Optionally, as shown in FIG. 4 and FIG. 10, the cylindrical side plate 1203b and the base plate 1203a are integrally molded, and a thickness H4 of the cylindrical side plate 1203b is the same as the thickness H3 of the base plate 1203a. Setting the thickness of the cylindrical side plate 1203b and the thickness of the base plate 1203a to be consistent can effectively ensure that the magnetic conduction shield 1203 provides optimal magnetic conductivity for the magnetic field of the magnet 1202 at various positions, thereby effectively ensuring the magnetic conductivity performance of the magnetic conduction shield 1203.

Optionally, as shown in FIG. 4 and FIG. 10, in some embodiments, the magnetic conduction plate 1201 is provided with a first through-hole 1201a along the preset vibration direction X1; and/or the base plate 1203a is provided with a second through-hole 1203c along the preset vibration direction X1. Specifically, in some embodiments, the magnetic conduction plate 1201 is provided with the first through-hole 1201a along the preset vibration direction X1, and the base plate 1203a is provided with the second through-hole 1203c along the preset vibration direction X1. The first through-hole 1201a and the second through-hole 1203c can effectively reduce a weight of the magnet assembly 120, thereby effectively reducing a weight of the core assembly 1. Optionally, in some embodiments, only the first through-hole 1201a may be provided on the magnetic conduction plate 1201, or only the second through-hole 1203c may be provided on the base plate 1203a.

Optionally, as shown in FIG. 4, a center of the first through-hole 1201a and a center of the second through-hole 1203c are collinear in the preset vibration direction X1; and/or, a projection of the first through-hole 1201a on the base plate 1203a along the preset vibration direction X1 falls within the second through-hole 1203c. Specifically, in the embodiments, the magnetic conduction plate 1201 is provided with the first through-hole 1201a, and the base plate 1203a is provided with the second through-hole 1203c. The center of the first through-hole 1201a and the center of the second through-hole 1203c are collinear in the preset vibration direction X1, so that the uniformity of the magnetic field of the magnet 1202 can be effectively ensured and the structural stability of the magnet assembly 120 can be effectively enhanced. Further, in the embodiments, the projection of the first through-hole 1201a along the preset vibration direction X1 on the base plate 1203a falls into the second through-hole 1203c, so that the homogeneity of the magnetic field and the structural stability of the magnet assembly 120 can be further enhanced.

Optionally, in some embodiments, the first through-hole 1201a and the second through-hole 1203c may only exist in any one of the above positional relationships (i.e., “the center of the first through-hole 1201a and the center of the second through-hole 1203c are collinear in the preset vibration direction X1” and “the projection of the first through-hole 1201a along the preset vibration direction X1 falls into the second through-hole 1203c”), which will not be discussed in detail herein.

The above is only an example of the present disclosure, and is not intended to limit the scope of the patent of the present disclosure, and any equivalent structure or equivalent process transformations utilizing the contents of the specification of the present disclosure and the accompanying drawings, or applying them directly or indirectly in other related fields of technology, are included in the scope of patent protection of the present disclosure. The patent protection of this application is included in the scope of this application.

What is claimed is:

1. A diaphragm, comprising:
a center main body; and
a folded ring connected to an outer peripheral edge of the center main body, wherein the folded ring includes two arcuate segments and two connecting segments, the two arcuate segments are spaced apart and disposed opposite to each other, and the two connecting segments are disposed spaced apart side-by-side and connected one-to-one between two pairs of opposite ends of the two arcuate segments, wherein
each arcuate segment of the two arcuate segments is provided with a plurality of first pattern grooves spaced apart from each other in an extension direction of the arcuate segment,
two ends of each first pattern groove extend towards an inner ring and an outer ring of the folded ring, respectively, and
the plurality of first pattern grooves are arranged in a radial arrangement along a same spiral direction.

2. The diaphragm according to claim 1, wherein
a depth of each first pattern groove decreases gradually towards the two ends of the first pattern groove, and
a width of a groove opening of the first pattern groove decreases gradually towards the two ends of the first pattern groove.

3. The diaphragm according to claim 2, wherein
a maximum depth of the first pattern groove is in a range of 0.06 mm˜0.1 mm, and
a maximum width of the groove opening of the first pattern groove is in a range of 0.14 mm˜0.18 mm.

4. The diaphragm according to claim 3, wherein
the maximum depth of the first pattern groove is located at a middle portion of an annular curved portion of the folded ring along a radial direction of the annular curved portion, and
the maximum width of the groove opening of the first pattern groove is located at the middle portion of the annular curved portion along the radial direction of the annular curved portion and at a surface of the annular curved portion.

5. The diaphragm according to claim 1, wherein
a ratio of a depth of each first pattern groove at any position to a width of a groove opening of the first pattern groove is in a range of 0.5˜4.

6. The diaphragm according to claim 1, wherein
a groove wall of each first pattern groove includes a curved bottom wall and two side walls disposed opposite to each other,
the curved bottom wall is connected between the two side walls and is disposed in a curved depression in a direction away from a groove opening of the first pattern groove, and
the curved bottom wall and the two side walls are smoothly connected.

7. The diaphragm according to claim 6, wherein an angle between the two side walls is in a range of 50° to 120°.

8. The diaphragm according to claim 6, wherein an angle between the two side walls is in a range of 60° to 100°.

9. The diaphragm according to claim 1, wherein
the folded ring includes an inner ring folded edge, an outer ring folded edge, and an annular curved portion connected between the inner ring folded edge and the outer ring folded edge,
the inner ring folded edge is connected to the center main body, and
the plurality of first pattern grooves are opened in the annular curved portion and located in the annular curved portion at a position corresponding to an arcuate segment of the two arcuate segments, wherein
each first pattern groove has a first end proximate to the inner ring folded edge and a second end proximate to the outer ring folded edge, and
a distance between the first end and the inner ring folded edge is less than a distance between the second end and the outer ring folded edge.

10. The diaphragm according to claim 1, wherein
the folded ring has a long axis direction and a short axis direction perpendicular to each other,
the two connecting segments extend along the long axis direction and are spaced apart along the short axis direction,
on a reference plane defined by the long axis direction and the short axis direction, each first pattern groove has a first projection, and an inner edge of the folded ring has a second projection,
the second projection and an extension line of the first projection have an intersection point on the reference plane, and
at the intersection point, an angle between the extension line of the first projection and a tangent line of the second projection is greater than or equal to 30° and less than 90°.

11. The diaphragm according to claim 10, wherein the angle corresponding to the first pattern groove decreases gradually along a direction from a middle point of an arcuate segment of the two arcuate segments towards each end of the arcuate segment, wherein
the angle corresponding to the first pattern groove closer to the middle point of the arcuate segment is larger, and
the angle corresponding to the first pattern groove closer to each end of the arcuate segment is smaller.

12. The diaphragm according to claim 1, wherein
the plurality of first pattern grooves of the two arcuate segments have the same spiral direction.

13. The diaphragm according to claim 1, wherein
at least one of the two connecting segments is provided with a plurality of second pattern grooves spaced apart from each other, two ends of each second pattern groove extending towards the inner ring and the outer ring of the folded ring, respectively.

14. The diaphragm according to claim 13, wherein
the folded ring has a long axis direction and a short axis direction perpendicular to each other,
the two connecting segments extend along the long axis direction and are spaced apart along the short axis direction,
an angle between the short axis direction and an extension direction of a projection of a second pattern groove of the plurality of second pattern grooves on a reference plane defined by the long axis direction and the short axis direction is less than 5°.

15. The diaphragm according to claim 14, wherein
the plurality of second pattern grooves are divided into at least two groups of second pattern grooves,
in each group of second pattern grooves, there is a first interval distance between two second pattern grooves that are adjacent to each other,
there is a second interval distance between two adjacent groups of second pattern grooves,
the first interval distance is less than the second interval distance,
there is a third interval distance between a second pattern groove of the plurality of second pattern grooves and a first pattern groove of the plurality of first pattern grooves that is closest to each other, and
the first interval distance is less than the third interval distance.

16. The diaphragm according to claim 15, wherein
the second pattern grooves in each group are uniformly arranged at the first interval distance in a first portion of the connecting segment, while two groups of second pattern grooves are separated by the second interval distance in a second portion of the connecting segment, wherein a deformation in the first portion is more severe than that in the second portion.

17. The diaphragm according to claim 15, wherein
the at least two groups of second pattern grooves include two groups,
the two groups of second pattern grooves are symmetrically spaced apart at two ends of the connecting segment by the second interval distance in the long axis direction.

18. An air conduction speaker, comprising a frame, a drive assembly, and a diaphragm, wherein the diaphragm includes:
a center main body; and
a folded ring connected to an outer peripheral edge of the center main body, wherein the folded ring includes two arcuate segments and two connecting segments, the two arcuate segments are spaced apart and disposed opposite to each other, and the two connecting segments are disposed spaced apart side-by-side and connected one-to-one between two pairs of opposite ends of the two arcuate segments, wherein
each arcuate segment of the two arcuate segments is provided with a plurality of first pattern grooves spaced apart from each other in an extension direction of the arcuate segment,
two ends of each first pattern groove extend towards an inner ring and an outer ring of the folded ring, respectively, and
the plurality of first pattern grooves are arranged in a radial arrangement along a same spiral direction,
the drive assembly is at least partially surrounded by the frame,
the folded ring is fixed on the frame, and
the drive assembly is coupled to the center main body.

19. A wearable electronic device, comprising a housing and an air conduction speaker, the air conduction speaker being provided in an interior of the housing, wherein the air conduction speaker includes a frame, a drive assembly, and a diaphragm, wherein the diaphragm includes:
a center main body; and
a folded ring connected to an outer peripheral edge of the center main body, wherein the folded ring includes two arcuate segments and two connecting segments, the two arcuate segments are spaced apart and disposed opposite to each other, and the two connecting segments are disposed spaced apart side-by-side and connected one-to-one between two pairs of opposite ends of the two arcuate segments, wherein
each arcuate segment of the two arcuate segments is provided with a plurality of first pattern grooves spaced apart from each other in an extension direction of the arcuate segment,
two ends of each first pattern groove extend towards an inner ring and an outer ring of the folded ring, respectively, and
the plurality of first pattern grooves are arranged in a radial arrangement along a same spiral direction,
the drive assembly is at least partially surrounded by the frame,
the folded ring is fixed on the frame, and
the drive assembly is coupled to the center main body.

20. The wearable electronic device according to claim 19, wherein the wearable electronic device includes a bone conduction speaker, the bone conduction speaker being disposed in the interior of the housing and spaced apart from the air conduction speaker.
